(19) United States
(12) Patent Application Publication
(10) Pub. No.: US 2007/0137773 A1
(43) Pub. Date: Jun. 21, 2007

(54) DIE BONDING APPARATUS AND METHOD OF OPERATING THE SAME

(76) Inventors: Yung-Fong Chen, Yilan County (TW); Cheng-Wen Ou, Hsinchu County (TW); In-Shieh Liu, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,103

(22) Filed: Dec. 16, 2005

(51) Int. Cl. B32B 37/12; B44C 1/17

(52) U.S. Cl. 156/235; 156/541; 156/542; 156/238; 156/249

(57) ABSTRACT

A die bonding apparatus comprising a tape transfer device and a bonding device is provided. The tape transfer device includes a roller tape and a first roller axle. The roller tape comprises a plurality of glue layers and a first releasing film. Both surfaces of the glue layers are adhesive. The first releasing film covers one of the surfaces of the glue layers. The first roller axle is used for rolling up the first releasing film so as to rotate the roller tape. The bonding device is disposed at the front end of the tape transfer device. The bonding device includes at least a robotic arm and a controller. The controller controls the rotation and movement of the robotic arm.

### BACKGROUND OF THE INVENTION

1. Field of the Invention

The present invention relates to a semiconductor apparatus and method of operating the same. More particularly, the present invention relates to a die bonding apparatus and method of operating the same.

2. Description of the Related Art

In the semiconductor industry, the production of integrated circuits can be roughly divided into three processing stages: the wafer manufacturing stage, the integrated circuit fabrication stage and the integrated circuit packaging stage. The steps for producing a chip include wafer fabrication, circuit design, mask production and wafer sawing. In general, each chip cut out from a wafer must be attached to a glass substrate or other substrate before subsequent processes can be performed.

The conventional method of attaching a chip to a glass substrate includes spot gluing. After putting a couple of glue spots on the back of the chip, the back of the chip is made in contact with the glass substrate. Then, heat is added to the substrate to cure the plastic adhesive so that the chip and the glass substrate are bonded tightly together. However, due to the uneven distribution of the glue or the occurrence of bubbles in the glue in the spot gluing process, the chip is likely to peel off, which will affect the reliability of subsequent processes.

To resolve the above issue, a bonding method that uses a double-sided tape has been developed to replace the conventional spot gluing process. FIGS. 1A through 1D are a series of perspective views showing the steps for bonding a chip to a substrate. As shown in FIG. 1A, the top releasing film 102 of a three-layered double-sided adhesive tape 100 is peeled off manually. Then, as shown in FIG. 1B, the top adhesive surface of the double-sided adhesive tape 110 is attached to the surface of the glass substrate 104. Next, as shown in FIG. 1C, the bottom releasing film 106 is peeled off manually. After that, as shown in FIG. 1D, a chip 108 is manually bonded to the bottom adhesive surface of the double-sided adhesive tape 100. At the end of these series of steps, the chip and the glass substrate are bonded together.

Accordingly, the conventional chip bonding method comprises a series of tedious and trivial steps. The bonding method not only wastes a lot of time, but also highly requires man power. Furthermore, since each step of the process is very time consuming, thus, the production rate is low and the productivity can not be improved.

### SUMMARY OF THE INVENTION

Accordingly, at least one objective of the present invention is to provide a die bonding apparatus, capable of performing the die bonding process automatically to save time and labor and increase production rate and yield.

At least another objective of the present invention is to provide a method of operating a die bonding apparatus that can prevent uneven distribution of glue or trapped bubbles in the glue in a spot-gluing process. Furthermore, the method provided by the present invention automates the die bonding process. Thus, considerable time and manual labor are saved.

To achieve these and other advantages and in accordance with the purpose of the invention, as embodied and broadly described herein, the invention provides a die bonding apparatus. The die bonding apparatus comprises a tape transfer device and a bonding device. The tape transfer device includes a roller tape and a first roller axle. The roller tape comprises a plurality of glue layers and a first releasing film. Both surfaces of the glue layers are adhesive. The first releasing film covers one of the surfaces of the glue layers. The first roller axle is used for rolling up the first releasing film and rotating the roller tape. The bonding device is disposed at the front end of the tape transfer device. The bonding device includes at least a robotic arm and a controller. The controller controls the rotation and movement of the robotic arm.

According to the embodiment of the present invention, the foregoing tape transfer device further includes a first set of rollers for advancing the first releasing film to the first roller axle.

According to the embodiment of the present invention, the foregoing roller tape further includes a second releasing film that covers the other surface. The tape transfer device further includes a second roller axle disposed above the first roller axle for rolling up the second releasing film so as to rotate the roller tape. In one embodiment, the tape transfer device further includes a second set of rollers for advancing the second releasing film to the second roller axle.

According to the embodiment of the present invention, the foregoing roller tape is a high temperature resistant roller tape.

The present invention also provides a method of operating a die bonding apparatus. The operating method includes rotating a first roller axle to roll up a first releasing film released from a roller tape and rotating the roller tape such that a plurality of glue layers on the first releasing film of the roller tape advances toward a bonding device. Then, at least one robotic arm of the bonding device moves in cycles to bond a plurality of dies and a plurality of substrate using the glue layers.

According to the embodiment of the present invention, the cyclic transfer motion for bonding the dies and the substrates using the glue layers includes the following steps: (a) using the robotic arm to pick up a die and bonding the die to a glue layer, (b) moving the robotic arm to an area above the substrate and bonding the side of the die with the glue layer to the substrate, (c) separating the robotic arm from the die, and (d) repeating the steps from (a) to (c).

According to the embodiment of the present invention, the cyclic transfer motion for bonding the dies and the substrates using the glue layers includes the following steps: (a) using a first robotic arm to pick up a die and bonding the die to a glue layer, and separating the first robotic arm from the die, (b) using a second robotic arm to pick up the die, (c) moving the second robotic arm to an area above a substrate and bonding the die with the glue layer to the substrate, (d) separting the second robotic arm from the die, and (e) repeating the steps from (a) to (d).

According to the embodiment of the present invention, rotating the first roller axle also includes driving a set of rollers into rotation so that the first releasing film advances to the first roller axle.

According to the embodiment of the present invention, the method of controlling the movement of the robotic arm includes using the controller in the bonding device.

According to the embodiment of the present invention, rotating the first roller axle also includes driving a second roller axle into rotation for rolling up the second releasing film released from the roller tape so as to rotate the roller tape. In one embodiment, rotating the second roller axle also includes driving a second set of rollers into rotation so that the second releasing film advances to the second roller axle.

According to the embodiment of the present invention, the foregoing roller tape is a high temperature resistant roller tape.

The die bonding apparatus in the present invention uses a tape transfer device to automatically tear off the releasing film from the tape, and utilizes a bonding device to bond a die and a substrate together, so that the whole die bonding process is performed in an integral manner. In this way, the die bonding process is automated and considerable time and labor are saved. Furthermore, because a glue layer with adhesive on both sides is used to bond the die to the substrate, the problems of having uneven distribution of glue or some bubbles trapped within the glue in the conventional spot-gluing process can be avoided.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A through 1D are a series of perspective views showing the steps for bonding a chip to a substrate in the prior art.

FIG. 2 is a schematic diagram showing a die bonding apparatus according to one embodiment of the present invention.

FIG. 3 is a schematic diagram showing the method of operating a die bonding apparatus according to one embodiment of the present invention.

FIG. 4 is a schematic diagram showing the method of operating a die bonding apparatus according to another embodiment of the present invention.

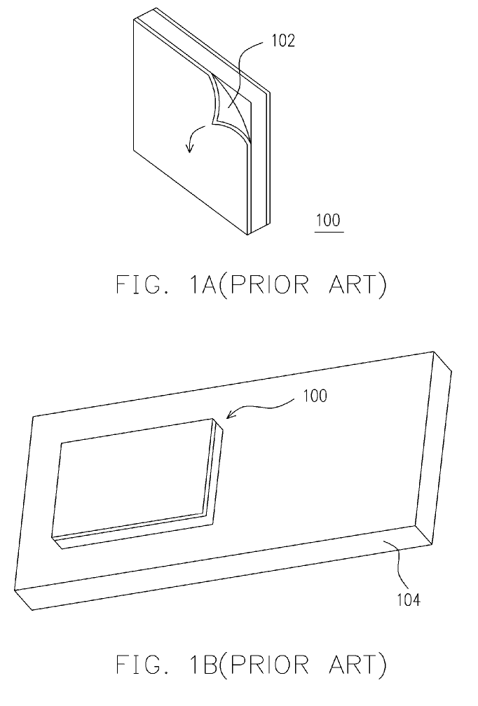

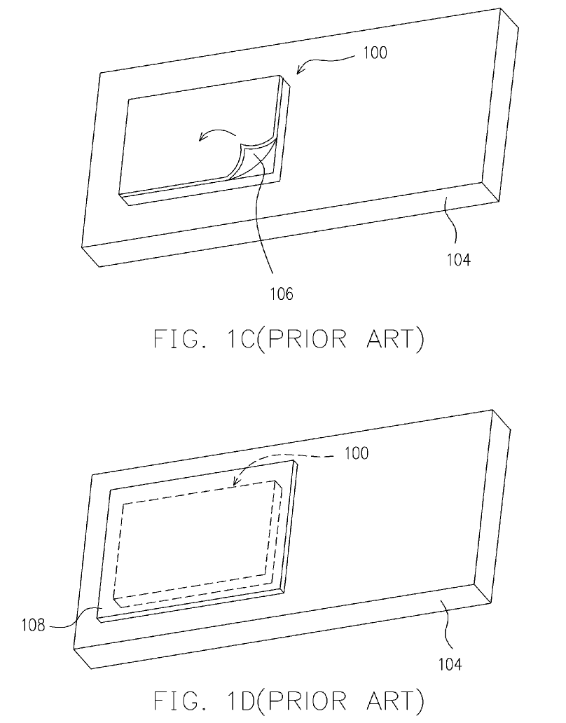

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

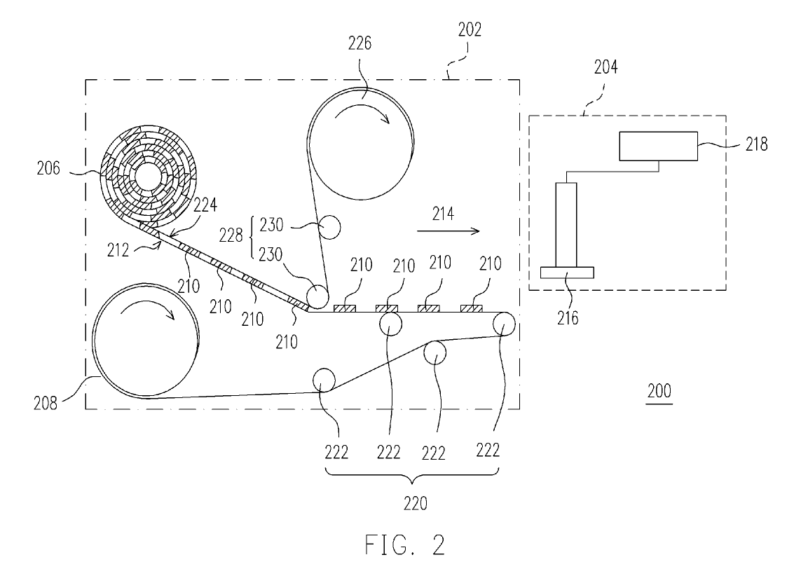

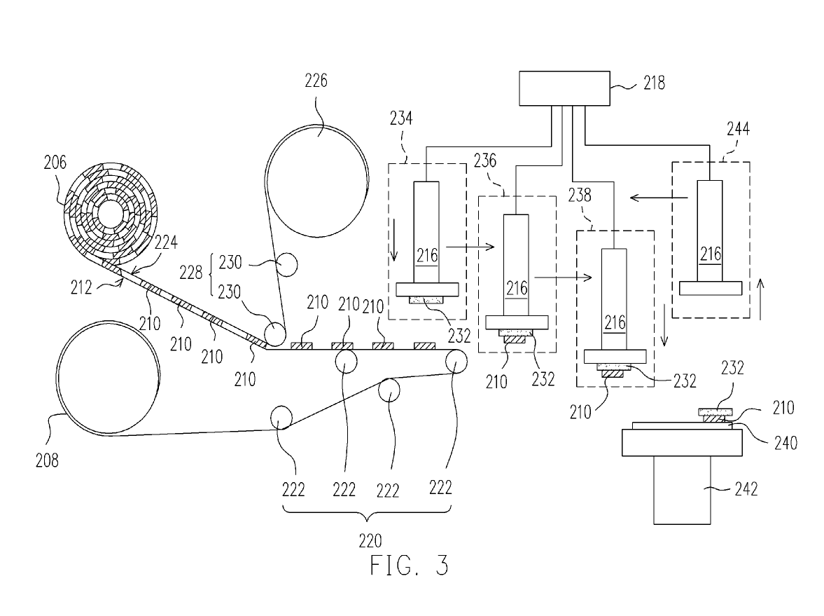

FIG. 2 is a schematic diagram showing a die bonding apparatus according to one embodiment of the present invention. As shown in FIG. 2, the die bonding apparatus 200 in the present invention mainly includes a tape transfer device 202 and a bonding device 204.

The tape transfer device 202 includes a roller tape 206 and a roller axle 208. The roller tape 208 is, for example, a high temperature resistant roller tape capable of withstanding a temperature up to about 100° C. The roller tape 206 comprises a plurality of glue layers 210 and a releasing film 212. The glue layers have adhesive on both surfaces and the releasing film 212 covers one of the surfaces of the glue layers 210. The releasing film 212 can be regarded as a conveyor belt for transporting the glue layers 210. The roller axle 208 is used for rolling up the releasing film 212 and rotating the roller tape 206 so that the glue layers 210 can advance in the direction of the bonding device 204 (indicated by the arrow 214) along with the releasing film 212.

The bonding device 204 is disposed at the front end of the tape transfer device 202. The bonding device 204 includes at least a robotic arm 216 and a controller 218. The controller 218 can control the robotic arm 216 to freely perform rotation and movement. The robotic arm 216 is a device for gripping or sucking up a die (or a substrate) so that the die or substrate can bond with a glue layer 210. In FIG. 2, only a single robotic arm 216 is illustrated in the bonding device 204. However, two or more than two robotic arms can be used. In fact, the present invention does not limit on the number of robotic arms deployed in the bonding device 204 and the actual number depends on the desired conditions.

In one embodiment, the tape transfer device 202 of the present invention may further include a set of rollers 220 for advancing the releasing film 212 towards the roller axle 208. In FIG. 2, the set of rollers 220 has altogether four rollers 222. Obviously, there is no set limit on the number of rollers 222 in the set of rollers 220. In practice, the number of rollers 222 can be increased or decreased according to the actual working conditions.

In another embodiment, the roller tape 206 may further include another releasing film 224 that covers the other surface of the glue layers 210. The tape transfer device 202 may further include another roller axle 226 disposed above the roller axle 208 for rolling up the releasing film 224 and assisting in rotating the roller tape 206. In yet another embodiment, another set of rollers 228 for advancing the releasing film 224 towards the roller axle 226 may also be added. In FIG. 2, the set of rollers 228 includes only two rollers 230. Obviously, there is no set limit on the number of rollers 230 in the set of rollers 228. In practice, the number of rollers 222 can be adjusted according to the actual working conditions.

Accordingly, the die bonding apparatus 200 of the present invention uses the tape transfer device 202 to detach the tape, and utilizes the bonding device 204 to bond a die and a substrate together, so that the whole die bonding process is performed automatically. In this way, the die bonding process is automated and considerable time and labor are saved. Furthermore, because a glue layer with adhesive on both sides is used to bond the die to the substrate, the problems of having an uneven distribution of glue or some bubbles trapped within the glue in the conventional spot-gluing process can be avoided.

In the following, a method of operating the die bonding apparatus of the present invention is described. The die bonding process is explained using the die bonding apparatus 200.

As shown in FIG. 2, the method of operating the die bonding apparatus of the present invention includes rotating the roller axle 208, for example, in a clockwise direction. Rotating the roller axle 208 can roll up the releasing film 212 released from the roller tape 206 so as to rotate the roller tape 206, for example, in an counterclockwise direction. The releasing film 212 has a function similar to a conveyer belt such that the glue layers 210 on the releasing film 212 advance in the direction toward the bonding device 204.

In one embodiment, a set of rollers 220 can be used to advance the releasing film 232 to the roller axle 208 when the roller axle 208 rotates. Aside from assisting the roll up of the releasing film 212 of the roller tape 206, the set of rollers 220 can also be designed with proper number and layout that a transport pathway is provided according to the actual condition.

In another embodiment, the roller tape 206 may further include another releasing film 224. Thus, the method of operating the die bonding apparatus of the present invention may include using the roller axle 226 as an assistant to drive the roller tape 206 into rotation. The method includes rotating the roller axle 226 together with the roller axle 208 to roll up the releasing film 224 of the roller tape 206 so as to rotate the roller tape 206. The roller axle 226 rotates, for example, in the clockwise direction. Furthermore, in another embodiment, a set of rollers 228 may also rotate to advance the releasing film 224 to the roller axle 226 when the roller axle 226 rotates.

In the foregoing description, the process of automatically releasing the film from the tape in the die bonding process is explained. However, the robotic arm 216 of the bonding device 204 must also move in cycles to bond the dies and the substrates together through the glue layers 210 to complete the automatic bonding process after the glue layers 210 have advanced to the bonding device 204. Typically, the movement of the robotic arm 21 6 is controlled by means of the controller 218 of the bonding device 204.

FIG. 3 is a schematic diagram showing the method of operating a die bonding apparatus according to one embodiment of the present invention. The cyclic transfer of the glue layers to bond a die and a substrate together, for example, includes using the robotic arm 216 to suck up or grip a die 232 (labeled 234). Then, the robotic arm 216 is lowered so that a glue layer 210 is attached to one of the surfaces of the die 232 (labeled 236). Next, the robotic arm 216 is moved to an area above a substrate 240 (labeled 238) while the substrate 240 is disposed on a working platform 242. After that, the robotic arm 216 is lowered so that the die 232 and the glue layer 210 are bonded to the substrate 240. Then, the die 232 is released (labeled 244). The above description is one cycle for bonding a die to a substrate via a glue layer. By matching the advancing speed of the tape with the transfer speed of the robotic arm, the die bonding apparatus can provide a continuous die bonding process.

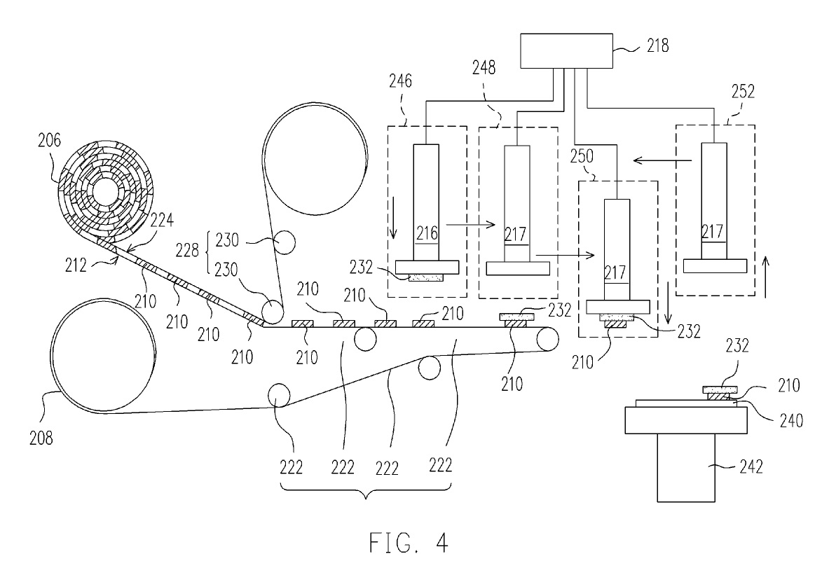

FIG. 4 is a schematic diagram showing the method of operating a die bonding apparatus according to another embodiment of the present invention. The cyclic transfer of the glue layer to bond a die and a substrate together, for example, includes using the robotic arm 216 to suck up or grip a die 232 (labeled 246). Then, the robotic arm 216 is lowered so that a glue layer 210 is attached to one of the surfaces of the die 232. Next, the die 232 is released and the robotic arm 216 is lifted up to repeat the process of attaching a die 232 to the surface of a glue layer 210. After attaching a die 121 to the surface of a glue layer 210, another robotic arm 217 is lowered (label 248) to suck up or grip the die 232. Then, the robotic arm 217 is moved to an area above a substrate 240 (labeled 250) while the substrate 240 is disposed on a working platform 242. After that, the robotic arm 217 is lowered so that the die 232 and the glue layer 210 are attached to the substrate 240. Then, the die 232 is released (labeled 252). The above description is one cycle for bonding a die to a substrate via a glue layer. By matching the advancing speed of the tape with the transfer speeds of the two robotic arms, the die bonding apparatus can provide a continuous die bonding process.

The aforementioned die bonding apparatus 200 in the present invention is illustrated with one robotic arm and two robotic arms, respectively. However, the die bonding apparatus can have more than two robotic arms. Since the conditions for operating such as die bonding apparatus should be familiar to the technical personnel having knowledge in this area, a detailed description is omitted.

In summary, the major advantages of the present invention include at least:
1. An automated die bonding apparatus is used to perform the die bonding process. Hence, considerable time and labor are saved so that the production rate and the yield can be increased.
2. Because a glue layer with adhesive on both sides is used to bond the die and the substrate together, the problem of having an uneven distribution of the glue or some bubbles trapped within the glue in a conventional spot-gluing process can be avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A die bonding apparatus, comprising:
a tape transfer device, comprising:
a roller tape having a plurality of glue layers and a first releasing film, wherein the glue layers have adhesive on both surfaces and the first releasing film covers one of the surfaces of the glue layers; and
a first roller axle for rolling up the first releasing film released from the roller tape so as to rotate the roller tape; and
a bonding device disposed at the front end of the tape transfer device, and the bonding device comprising at least a robotic arm and a controller, wherein the controller controls the rotation and movement of the robotic arm.

2. The die bonding apparatus of claim 1, wherein the tape transfer device further comprises a first set of rollers for advancing the first releasing film toward the first roller axle.

3. The die bonding apparatus of claim 1, wherein the roller tape further comprises a second releasing film that covers the other surface of the glue layers, and the tape transfer device further includes a second roller axle disposed above the first roller axle for rolling up the second releasing film released from the roller tape so as to rotate the roller tape.

4. The die bonding apparatus of claim 3, wherein the tape transfer device further comprises a second set of rollers for advancing the second releasing film toward the second roller axle.

5. The die bonding apparatus of claim 1, wherein the roller tape comprises a high temperature resistant roller tape.

6. A method of operating a die bonding apparatus, comprising:
rotating a first roller axle to roll up a first releasing film released from a roller tape and rotate the roller tape so that a plurality of glue layers on the first releasing film advance toward a bonding device; and
moving at least a robotic arm of the bonding device in cycles to bond a plurality of dies to a plurality of substrates using the glue layers.

7. The operating method of claim 6, wherein moving in cycles to bond the dies to the substrates using the glue layers comprises:
a) using the robotic arm to pick up a die and bonding the die to a glue layer;
b) moving the robotic arm to an area above a substrate and attaching the side of the die with the glue layer thereon to the substrate;
c) releasing the robotic arm from the die; and
d) repeating the steps from (a) to (c).

8. The operating method of claim 6, wherein moving in cycles to bond the dies to the substrates using the glue layers comprises:
a) using a first robotic arm to pick up a die, attaching the die to a glue layer and releasing the first robotic arm from the die;
b) using a second robotic arm to pick up the die;
c) moving the second robotic arm to an area above a first substrate and attaching the die with the glue layer thereon to the substrate;
d) releasing the second robotic arm from the die; and
e) repeating the steps from (a) to (d).

9. The operating method of claim 6, wherein the step of rotating the first roller axle further comprises rotating a set of first rollers so that the first releasing film advances toward the first roller axle.

10. The operating method of claim 6, wherein moving the robotic arms of the bonding device is controlled by a controller inside the bonding device.

11. The operating method of claim 6, wherein the step of rotating the first roller axle comprises rotating a second roller axle to roll up a second releasing film released from the roller tape so as to rotate the roller tape.

12. The operating method of claim 11, wherein the step of rotating the second roller axle further comprises rotating a second set of rollers so that the second releasing film advances toward the second roller axle.

13. The operating method of claim 6, wherein the roller tape comprises a high temperature resistant roller tape.
